(19) United States
(12) Patent Application Publication
(10) Pub. No.: US 2022/0225822 A1
(43) Pub. Date: Jul. 21, 2022

(54) Cooking Utensil Comprising An Aluminum Shell

(71) Applicant: SEB S.A., Ecully (FR)

(72) Inventor: Laurent Aubin, Rumilly (FR)

(73) Assignee: SEB S.A., Ecully (FR)

(21) Appl. No.: 17/613,710

(22) PCT Filed: May 19, 2020
(86) PCT No.: PCT/EP2020/064010

§ 371 Date: Nov. 23, 2021

(30) Foreign Application Priority Data
May 23, 2019 (FR) FR1905455

(51) Int. Cl. A47J 36/02; A47J 27/00

(52) U.S. Cl. CPC A47J 36/02; A47J 27/002

(57) ABSTRACT

A cooking utensil having a metal shell includes a bottom wall and a side wall rising up around the bottom wall, the bottom wall having an inner face configured to cook food and an outer face configured for placing in proximity to a source of heat, wherein the shell is a deep-drawn or flow-formed 6082 aluminum alloy sheet from the 6000 series, or the 5083 alloy from the 5000 series, and a method of manufacturing same.

The present invention relates to the technical field of cooking utensils or cooking vessels produced from a deep-drawn or flow-formed aluminum alloy sheet.

Cooking vessels generally comprise a bottom intended to be placed on a cooking hob (such as an electric hot plate, an induction heating plate, a fuel burner, or similar), said bottom being surrounded by a side wall rising up around the bottom. The upper face of the bottom forms a cooking surface for the food. The lower face of the bottom forms a heating surface.

The present invention relates in particular, but not exclusively, to skillet-type cooking vessels. Skillet-type cooking vessels may be defined by a height that is less than their width or diameter. Generally the width or diameter of such cooking vessels is several times greater than their height.

The use of aluminum alloys in the field of cooking has been known for years. The good thermal conductivity of aluminum makes it possible to consider producing cooking vessels having an aluminum alloy body.

In cooking vessels having an aluminum alloy body, the side wall acts as a cooling fin, which contributes to limiting the heating of the peripheral part of the bottom. The result is a temperature differential on the bottom, particularly between the center and the periphery of the heating surface.

The distribution of the material used for a cooking vessel may be described by the bottom thickness/side wall thickness ratio. In normal practice for aluminum alloy cooking vessels, this bottom thickness/side wall thickness ratio does not exceed 1.8, particularly for cooking vessels produced from a deep-drawn or flow-formed aluminum alloy sheet. A skillet 28 cm in diameter has a bottom thickness of 5.1 mm and a side wall thickness of 2.9 mm, i.e., a ratio of 1.76.

One of the principal criteria for evaluating the quality of a cooking vessel is its cooking homogeneity. The cooking homogeneity refers to the ability of the cooking vessel to cook food uniformly, irrespective of the placement of the food on the bottom of the cooking vessel.

One disadvantage of aluminum alloy cooking vessels produced from deep-drawn or flow-formed aluminum alloy sheet is in the sensitivity of the cooking surface to temperature variations caused by the side wall. During preheating, significant temperature differences may be observed on the cooking surface, for example with a temperature of 180° C. at the hottest point of the cooking surface and less than 120° C. at the least hot point of the cooking surface. These temperature differences contribute to reducing the cooking homogeneity of the food cooked in the cooking vessel.

The objective is to manufacture cooking vessels with a distribution of material according to its thermal role, in order to improve its homogeneity and preheating properties while still limiting the increase in weight of the utensil.

An object of the present invention is to propose a cooking vessel comprising a shell of aluminum alloy produced from a deep-drawn or flow-formed aluminum alloy sheet, wherein the homogeneity of the temperature of the cooking surface is improved, without causing an excessive increase in the mass of the cooking vessel.

This object is achieved with a cooking utensil comprising a metal shell having a bottom wall and a side wall rising up around the bottom wall, said bottom wall having an inner face intended for cooking food and an outer face intended to be placed in proximity to a source of heat, a metal insert being mounted directly onto the outer face, the metal insert being produced from a ferromagnetic material, in such a way that the cooking utensil is compatible with induction heating, said shell being a deep-drawn or flow-formed aluminum alloy sheet from the 6000 series, due to the fact that said shell is a 6082 aluminum alloy sheet, and that the bottom wall has a thickness at least twice that of the side wall.

The use of aluminum alloys in the field of cooking has been known for years. However, the usual alloy grades (Al 1050, Al 1200, Al 3003, Al 4006) have mechanical strength properties that are weak.

It should be noted that the alloys used must comply with food grade standards (content of Zn<0.25% and content of Cu<0.6%).

The use of the 6082 alloy from the 6000 series makes it possible to reconsider the design of cooking vessels in order to improve their cooking homogeneity while reducing their mass and limiting the increase in preheating time. This alloy has a high elastic limit, and is harder than aluminum alloys normally used to produce cooking vessels, which makes it possible to consider further reducing the thickness of the side wall of the cooking vessel, due to this better mechanical strength.

6000 Series (Aluminum Magnesium Silicon)

The alloy elements of this series are magnesium (Mg) and silicon (Si). This alloy family is of great industrial importance. It is widely used for profiles.

They have very good suitability for deformation (primarily spinning, stamping) and cold forming in the annealed condition. Their mechanical characteristics are average and are poorer than those of the 2000 and 7000 alloys. These characteristics can be increased by adding silicon, which will give the hardening precipitate Mg2Si. They have excellent corrosion resistance, particularly to atmospheric corrosion. They are easily welded (arc welding or brazing).

They can be divided into two groups:
one group, the compositions of which have a higher content of magnesium and silicon (6061, 6082 for example). They are used for structural applications (framing, pylons, etc.), as well as in aeronautics (electrical connections, onboard electronic housings, etc.);
a second category of lower silicon content, which as a result will have weaker mechanical characteristics. This is the case for the 6060, which will allow high-speed spinning but will have weaker mechanical characteristics. It will be used for example in decoration and furnishings, as well as metal joinery.

Note should also be made of the 6101, formerly called Almelec. This alloy was very widely used due to its suitability as an electrical conductor. In particular, it was used for manufacturing medium- and high-voltage lines in France.

TABLE 1
Composition

| | | | | | | | | | | | | Others, | Others, | |
|---|---|---|---|---|---|---|---|---|---|---|---|---|---|---|
| Alloy | — | Si | Fe | Cu | Mn | Mg | Cr | Ni | Zn | Ti | Zr*Ti | each | total | Al |
| 6060 | Min. | 0.03 | 0.10 | / | / | 0.35 | / | | / | i | / | / | / | the rest |
| | Max. | 0.60 | 0.30 | 0.10 | 0.10 | 0.60 | 0.05 | | 0.15 | 0.10 | / | 0.05 | 0.15 | |
| 6082 | Min. | 0.70 | / | / | 0.40 | 0.60 | / | | 1 | / | / | / | / | the rest |
| | Max. | 1.30 | 0.50 | 0.10 | 1.00 | 1.20 | 0.25 | | 0.20 | 0.10 | 1 | 0.05 | 0.15 | |
| 6101 | Min. | 0.30 | / | / | / | 0.35 | / | | / | / | 1 | / | / | the rest |
| | Max. | 0.70 | 0.50 | 0.10 | 0.03 | 0.80 | 0.30 | | 0.10 | / | 1 | 0.05 | 0.15 | |

Concentrations are in weight percent.

The use of the 5754 alloy from the 5000 series makes it possible to reconsider the design of cooking vessels in order to improve their cooking homogeneity while reducing their mass and limiting the increase in preheating time. This alloy is harder than the 6082 aluminum alloy from the 6000 series, which also makes it possible to consider further reducing the thickness of the side wall of the cooking vessel, due to this better mechanical strength.

TABLE 2
5754 (AW-AlMg3): Nominal chemical composition % (per standard EN 573-1):

| | | | | | | | | | Others | | |
|---|---|---|---|---|---|---|---|---|---|---|---|
| Si | Fe | Cu | Mn | Mg | Cr | Zn | Remarks | Ti | Each | Total | Al |
| 0.40 | 0.40 | 0.10 | 0.50 | 2.6-36 | 0.30 | 0.20 | 0.10-0.6 Mn + Cr | 0.15 | 0.05 | 0.15 | Rest |

The use of the 5083 alloy from the 5000 series makes it possible to reconsider the design of cooking vessels in order to improve their cooking homogeneity while reducing their mass and limiting the increase in preheating time. This alloy is harder than the 5754 aluminum alloy from the 5000 series, which also makes it possible to consider further reducing the thickness of the side wall of the cooking vessel, due to this better mechanical strength.

TABLE 3
5083 (AW-AlMg4.5MnO.7): Nominal chemical
composition % (per standard EN 573-1):

| | | | | | | | | | Others | | |
|---|---|---|---|---|---|---|---|---|---|---|---|
| Si | Fe | Cu | Mn | Mg | Cr | Ni | Zn | Ti | Each | Total | Al |
| 0.40 | 0.40 | 0.10 | 0.4-1.0 | 4.0-4.9 | 0.05-0.25 | — | 0.25 | 0.15 | 0.05 | 0.15 | Rest |

5000 Series (Magnesium Aluminum)

The alloy element is magnesium (up to 5%). These are work hardening alloys.

These alloys have average mechanical characteristics that increase with the magnesium content. These characteristics will also increase with the amount of work hardening.

They have good suitability for deformation, although this suitability decreases if the magnesium content increases. They have excellent performance in welding and as a result are used in boilermaker welding. They also have good performance at low temperatures. They have good corrosion performance, which accounts for their use in marine applications.

They are used in naval construction, transportation, and the chemical industry.

TABLE 4
Composition

| | | | | | | | | | | | | Others, | Others, | |
|---|---|---|---|---|---|---|---|---|---|---|---|---|---|---|
| Alloy | — | Si | Fe | Cu | Mn | Mg | Cr | Ni | Zn | Ti | Zr + Ti | each | total | Al |
| 5005 | Min. | / | / | / | / | 0.50 | / | / | / | / | / | / | / | the rest |
| | Max. | 0.30 | 0.70 | 0.20 | 0.20 | 1.10 | 0.10 | / | 0.25 | / | / | 0.05 | 0.15 | |
| 5086 | Min. | / | / | / | 0.20 | 3.50 | 0.05 | / | / | / | / | / | / | the rest |
| | Max. | 0.40 | 0.50 | 0.10 | 0.70 | 4.50 | 0.25 | / | 0.25 | 0.15 | / | 0.05 | 0.15 | |

Concentrations are in weight percent.

Preferably, the bottom wall has a thickness at least 2.5 times greater than that of the side wall.

Preferably, the bottom wall has a thickness less than or equal to 15 times that of the side wall, preferably less than or equal to 13.5 times that of the side wall.

Preferably, the shell has a diameter/height ratio of less than 0.5, and preferably less than 0.3.

Preferably, the shell has a diameter/height ratio of between 0.5 and 0.1, and preferably between 0.3 and 0.1.

If desired, the inner face may be partially or entirely coated, particularly with a PTFE, ceramic or sol-gel coating.

If desired, the outer face may be partially or entirely coated, particularly with an enamel, PTFE, ceramic or sol-gel coating.

Preferably, the metal insert is formed by a grid.

This grid can be assembled by stamping, for example by cold stamping, preferably before forming the alloy sheet. Its thickness is between 0.3 and 1 mm, preferably about 0.6 mm. The holes of the grid can have a diameter of between 2 and 4 mm, preferably about 3 mm.

The metal insert is produced from a ferromagnetic material.

The metal insert makes the cooking utensil according to the invention compatible with induction heating.

Another object of the invention relates to a 6082 aluminum alloy from the 6000 series intended for manufacturing the metal shell of a cooking utensil.

Another object of the invention relates to a method of manufacturing a cooking utensil according to the invention, comprising the following steps:
Furnishing a 6082 aluminum alloy sheet from the 6000 series,
Optionally mounting a metal insert onto the outer face
Deep drawing or flow forming said sheet into the shell shape,
Optionally applying a PTFE, or ceramic, or sol-gel coating partially or entirely over the inner face,
Optionally applying an enamel, PTFE, ceramic, or sol-gel coating partially or entirely over the outer face.

Another object of the invention relates to the use of a metal shell in the form of a deep-drawn or flow-formed 6082 aluminum alloy sheet from the 6000 series in order to improve the preheating time of a cooking utensil.

The means used consists of increasing the thickness of the bottom wall and decreasing that of the side wall, which results in maximizing the bottom wall/side wall thickness ratio. The difficulty here is ideally distributing the material based on its thermal role while complying with the requirement of mechanical strength (particularly at the point of attachment of a handle on the side wall).

The implementation of these constructions does not use specific transformation methods. The parameters used during deep-drawing, flow-forming or stamping operations for assembling a bottom compatible with induction heating obviously must be adapted to the new thicknesses to be obtained. For example, the stamping force for inserting a grid will for example be significantly revised upward in order to compensate for the greater resistance to penetration of the grid that the new alloy will offer.

The invention will be better understood from the study of an exemplary embodiment, taken without any limitation, illustrated in the attached figures, in which:

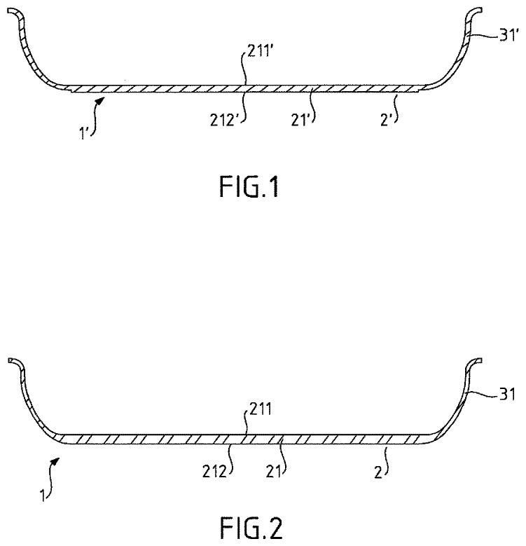

FIG. 1 is a schematic representation in cross-section of an exemplary embodiment of a cooking utensil according to the prior art,

FIG. 2 is a schematic representation in cross-section of an exemplary embodiment of a cooking utensil according to the invention,

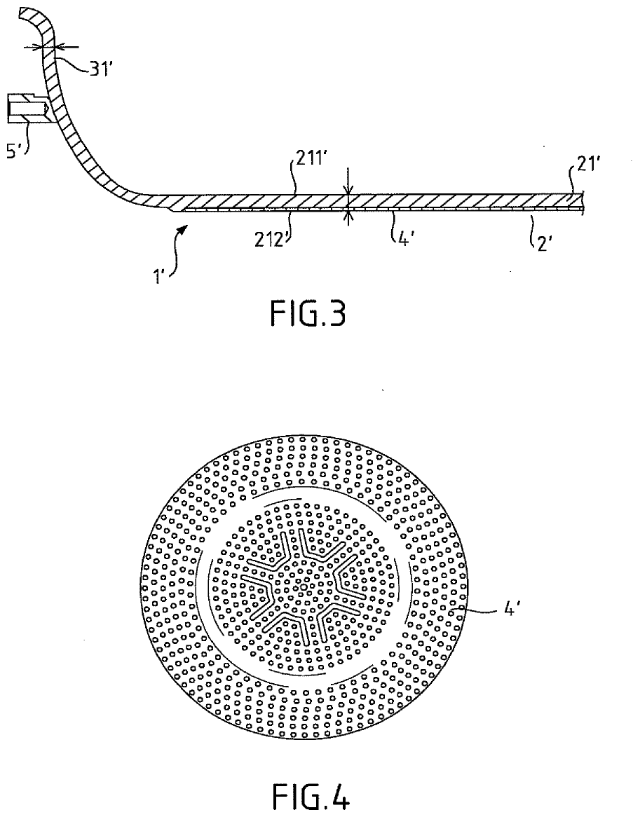

FIG. 3 is a partial schematic representation in cross-section of an alternative embodiment of a cooking utensil according to the prior art,

FIG. 4 is a representation of a metal insert inserted into the bottom of the cooking utensil illustrated in FIG. 3,

FIG. 5 is a partial schematic representation in cross-section of an alternative embodiment of a cooking utensil according to the invention,

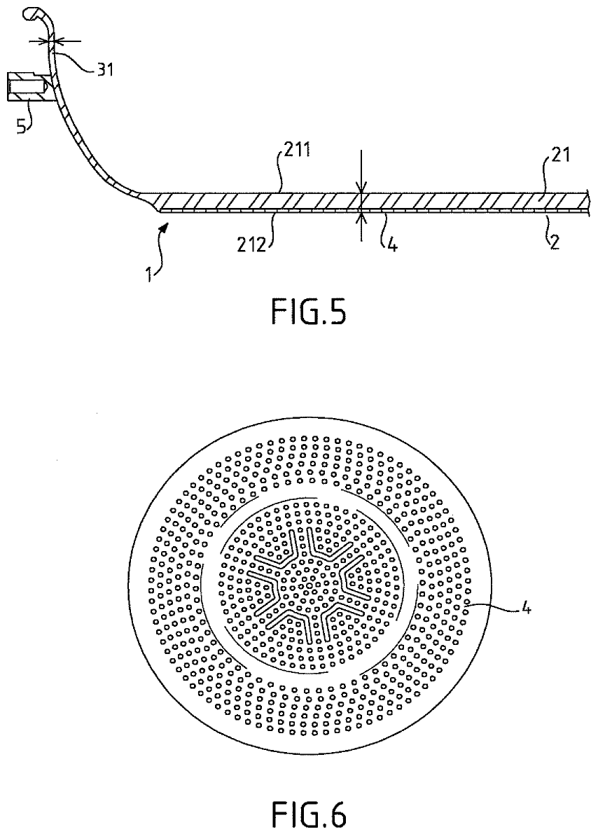

FIG. 6 is a representation of a metal insert inserted into the bottom of the cooking utensil illustrated in FIG. 5.

FIGS. 1 and 2 illustrate cooking utensils 1′, 1 comprising a metal shell 2′, 2 having a bottom wall 21′, 21 and a side wall 31′, 31 rising up around the bottom wall 21′, 21. The shell 2′, 2 is a flow-formed aluminum alloy sheet. As an alternative, the shell 2′, 2 could be a deep-drawn aluminum alloy sheet. The bottom wall 21′, 21 has an inner face 211′, 211 intended for cooking food and an outer face 212′, 212 intended to be placed in proximity to a source of heat. If desired, the inner face 211′, 211 may be partially or entirely coated with a coating, for example a PTFE coating, or a ceramic coating, or a sol-gel coating. If desired, the outer face 212′, 212 may be partially or entirely coated with a coating, for example a PTFE coating, or a ceramic coating, or a sol-gel coating. If desired, the cooking utensil 1′, 1 may comprise a handle (not shown in FIGS. 1 and 2) mounted on the shell 2′, 2.

According to the alternative embodiments illustrated in FIGS. 3 and 5, the cooking utensil 1′, 1 comprises a handle 5′, 5 attached to the shell 2′ 2. Furthermore, a metal insert 4′, 4 is mounted directly onto the outer face 212′, 212 of the bottom wall 21′, 21. FIGS. 4 and 6 show the metal inserts 4′, 4 that are present in the cooking utensils 1′, 1 shown in FIGS. 3 and 5. The metal inserts 4′, 4 are formed by grids. The metal inserts 4′, 4 may be produced from a ferromagnetic material, particularly from ferritic stainless steel, in order to obtain a cooking utensil 1′, 1 compatible with induction heating. The thickness of the metal inserts is for example of the order of 0.6 mm.

In the cooking utensils of the prior art illustrated in FIGS. 1, 3 and 4, the shell 2′ is a 4006 aluminum alloy sheet from the 4000 series, with a diameter of 28 cm. The bottom wall 21′ has a thickness of the order of 4.5 mm. The side wall 31′ has a thickness of the order of 3 mm, said side wall thickness corresponding to a minimum thickness measured below the outer edge of the shell 2′. The ratio between the thickness of the bottom wall 21′ and the thickness of the side wall 31′ is of the order of 1.5.

In the cooking utensils according to the invention illustrated in FIGS. 2, 5 and 6, the shell 2 is a 6082 aluminum alloy sheet from the 6000 series, with a diameter of 28 cm. The height of the shell 2 is of the order of 55 mm, i.e., a height/diameter ratio of the order of 0.2. The bottom wall 21 has a thickness of the order of 6 mm. The side wall 31 has a thickness of the order of 2 mm, said side wall thickness corresponding to a minimum thickness measured below the outer edge of the shell 2. The ratio between the thickness of the bottom wall 21 and the thickness of the side wall 31 is of the order of 3. As an alternative, the shell could be a 5754 aluminum alloy sheet from the 5000 series, or a 5083 aluminum alloy sheet from the 5000 series. As an alternative, the shell could have other diameters, and/or other heights, and/or other thicknesses of the bottom wall 21, and/or other thicknesses of the side wall 31.

### EXAMPLES

Tests were carried out with two 6082 alloy prototypes (PR21 and PR22) (skillet 28 cm in diameter, produced from 6082 alloy, corresponding to the alternative embodiment of FIG. 5, with a side wall thickness of 2 mm, a bottom wall thickness of 6 mm, a side wall height of 55 mm, a bottom diameter of 225 mm, and an openwork stainless steel grid with diameter of 225 mm, shown in FIG. 6).

The cooking utensil of reference used is the PO28GCBV Expertise skillet (skillet 28 cm in diameter, Grand Chef Edge pourer, produced from 4006 alloy, corresponding to the alternative embodiment of FIG. 3, with a side wall thickness of 3 mm, a bottom wall thickness of 4.5 mm, a side wall height of 55 mm, a bottom diameter of 210 mm, and an openwork stainless steel grid with diameter of 205 mm, shown in FIG. 4).

The two grids have an identical central part, the difference in diameter pertaining to a non-openwork outer ring.

Preheating Test

The preheating tests were carried out on an induction hob.

The preheating test consists of placing the empty skillet on the heating means. Once one of the points of the utensil reaches 180° C., the maximum temperature difference between two points of the bottom is measured in order to quantify the homogeneity criterion. The preheating time corresponds to the time necessary for a point to reach 180° C.

TABLE 5
Calculation of the T°max − min difference on the cooking
surface when T max = 180° C.

| | | ΔT⁰ | Gain |
|---|---|---|---|
| Standard Prod N^{o}1 | EXPERTISE | 93 | 35% |
| Prototype 6082 | PR22 | 60 | |

It will be noted that the increase of the bottom wall/side wall ratio improves the homogeneity of the cooking utensil while reducing the weight thereof.

Egg White Test

Egg white tests were carried out on several induction hobs (characteristics described in the table below).

This cooking test consists of determining the time necessary for the spread of coagulation of 150 g of egg white over 100% of the cooking surface of the skillet. To do this, beaten egg whites are poured into a cold skillet. The heating means is started; then the percent of coagulation is observed after stopping cooking and rinsing the uncoagulated part of the egg whites under water. The operation is repeated, increasing the cooking time by 10 seconds, until complete coagulation of the egg whites.

The increase of the thickness ratio relative to the standard thus makes it possible to significantly reduce this cooking time while still reducing the weight of the cooking utensil.

TABLE 6

| | Reference Plate | | | | | |
|---|---|---|---|---|---|---|
| | “BALAY” ® | | “WHIRLPOOL” ® | | “BOSCH” ® | |
| | Ref:3EB915LR | | Ref: ACM 701 | | Ref: PIL611B1SE | |
| | Power: 2200 W | | Power: 2000 W | | Power: 2200 W | |
| | Ø Inductor 230 mm | | Ø Inductor 250 mm | | Ø Inductor 272 mm | |
| | Time | Gain | Time | Gain | Time | Gain |
| EXPERTISE | 84 | | 67 | | 52 | |
| PR21 | 39 | 54% | 53 | 21% | 37 | 29% |

Other tests were carried out with two 5754 alloy prototypes and with two 5083 alloy prototypes (skillet 28 cm in diameter, corresponding to the alternative embodiment of FIG. 5, with a side wall thickness of 1.9 mm or 1 mm, a bottom wall thickness of 4.5 mm or 8 mm, a side wall height of 55 mm, a bottom diameter of 225 mm, and an openwork stainless steel grid with diameter of 205 mm, shown in FIG. 4).

The cooking utensil of reference used is also the PO28GCBV Expertise skillet (skillet 28 cm in diameter, Grand Chef Edge pourer, produced from 4006 alloy, corresponding to the alternative embodiment of FIG. 3, with a side wall thickness of 3 mm, a bottom wall thickness of 4.5 mm, a side wall height of 55 mm, a bottom diameter of 210 mm, and an openwork stainless steel grid with diameter of 205 mm, shown in FIG. 4).

Preheating Test

The preheating tests were carried out on an induction hob under the same conditions as the preceding test, except the average power was of the order of 2000 W instead of 2200 W.

TABLE 7
PREHEATING TEST
Calculation of the T° max − min difference on the cooking surface when T max = 180° C.

| | | Thickness Bottom | Thickness Skirt | Time to reach | T. avg. | T. min | T. max | Δ T° | Avg Pwr |
|---|---|---|---|---|---|---|---|---|---|
| No. | ALLOY | (mm) | (mm) | 180° C. (s) | [° C.] | [° C.] | [° C.] | (° C.) | (W) |
| PO 2 | 5754 | 4.5 | 1.9 | 42 | 132 | 55 | 183 | 128 | 2021 |
| PO 3 | 5754 | 8 | 1 | 75 | 148 | 96 | 180 | 84 | 2024 |
| PO 5 | 5083 | 4.5 | 1.9 | 40 | 131 | 63 | 180 | 117 | 2002 |
| PO 6 | 5083 | 8 | 1 | 70 | 148 | 102 | 181 | 79 | 2023 |
| Standard | 4006 | 4.5 | 3 | 58 | 140 | 91 | 181 | 90 | 2019 |

For a given alloy, it will be noted that the increase of the bottom wall/side wall ratio improves the heating homogeneity of the cooking utensil. It will also be noted that with the 5000 series alloys, a better heating homogeneity than that of the cooking utensil of reference can be obtained, by using a higher bottom wall/side wall ratio.

1-18. (canceled)

19. A cooking utensil comprising a metal shell having a bottom wall and a side wall rising up around the bottom wall, said bottom wall having an inner face configured for cooking food and an outer face configured to be placed in proximity to a source of heat, a metal insert mounted directly onto the outer face, the metal insert produced from a ferromagnetic material, in such a way that the cooking utensil is compatible with induction heating, said shell comprising a deep-drawn or flow-formed aluminum alloy sheet from the 6000 series, wherein said shell is a 6082 aluminum alloy sheet, and wherein the bottom wall has a thickness at least twice that of the side wall.

20. The cooking utensil according to claim 19, wherein the bottom wall has a thickness at least twice of that of the side wall.

21. The cooking utensil according to claim 19, wherein the bottom wall has a thickness at least 2.5 times greater than that of the side wall.

22. The cooking utensil according to claim 19, wherein the bottom wall has a thickness less than or equal to 15 times that of the side wall.

23. The cooking utensil according to claim 19, wherein the bottom wall has a thickness less than or equal to 13.5 times that of the side wall.

24. The cooking utensil according to claim 19, wherein the inner face is partially or entirely coated with a PTFE, or ceramic, or sol-gel coating.

25. The cooking utensil according to claim 19, wherein the outer face is partially or entirely coated with an enamel, or PTFE, or ceramic, or sol-gel coating.

26. The cooking utensil according to claim 19, wherein the metal insert is formed by a grid.

27. The cooking utensil according to claim 19, wherein the shell has a diameter/height ratio of less than 0.5.

28. The cooking utensil according to claim 19, wherein the shell has a diameter/height ratio of less than 0.3.

29. The cooking utensil according to claim 19, wherein the shell has a diameter/height ratio of between 0.5 and 0.1.

30. The cooking utensil according to claim 19, wherein the shell has a diameter/height ratio of between 0.3 and 0.1.

31. A cooking utensil comprising a metal shell having a bottom wall and a side wall rising up around the bottom wall, said bottom wall having an inner face configured for cooking food and an outer face configured to be placed in proximity to a source of heat, a metal insert mounted directly onto the outer face, the metal insert produced from a ferromagnetic material, in such a way that the cooking utensil is compatible with induction heating, said shell comprising a deep-drawn or flow-formed aluminum alloy sheet from the 5000 series, wherein said shell is a 5083 aluminum alloy sheet, and wherein the bottom wall has a thickness at least twice that of the side wall.

32. The cooking utensil according to claim 31, wherein the bottom wall has a thickness at least twice that of the side wall.

33. The cooking utensil according to claim 31, wherein the bottom wall has a thickness at least 2.5 times greater than that of the side wall.

34. The cooking utensil according to claim 31, wherein the bottom wall has a thickness less than or equal to 15 times that of the side wall).

35. The cooking utensil according to claim 31, wherein the bottom wall has a thickness less than or equal to 13.5 times that of the side wall.

36. The cooking utensil according to claim 31, wherein the inner face is partially or entirely coated with a PTFE, or ceramic, or sol-gel coating.

37. The cooking utensil according to claim 31, wherein the outer face is partially or entirely coated with an enamel, or PTFE, or ceramic, or sol-gel coating.

38. The cooking utensil according to claim 31, wherein the metal insert is formed by a grid.

39. The cooking utensil according to claim 31, wherein the shell has a diameter/height ratio of less than 0.5.

40. The cooking utensil according to claim 31, wherein the shell has a diameter/height ratio of less than 0.3.

41. The cooking utensil according to claim 31, wherein the shell has a diameter/height ratio of between 0.5 and 0.1.

42. The cooking utensil according to claim 31, wherein the shell has a diameter/height ratio of between 0.3 and 0.1

43. A 6082 aluminum alloy from the 6000 series configured for manufacturing the metal shell of a cooking utensil according to claim 19.

44. A 5083 aluminum alloy from the 5000 series configured for manufacturing the metal shell of a cooking utensil according to claim 31.

45. A method of manufacturing a cooking utensil according to claim 19, comprising the following steps:
furnishing a 6082 aluminum alloy sheet from the 6000 series;
optionally mounting a metal insert onto the outer face;
deep drawing or flow forming said sheet into the shell shape;
optionally applying a PTFE, or ceramic, or sol-gel coating partially or entirely over the inner face; and
optionally applying an enamel, PTFE, ceramic, or sol-gel coating partially or entirely over the outer face.

46. A method of manufacturing a cooking utensil according to claim 20, comprising:
furnishing a 5083 aluminum alloy sheet from the 5000 series;
optionally mounting a metal insert onto the outer face;
deep drawing or flow forming said sheet into the shell shape;
optionally applying a PTFE, or ceramic, or sol-gel coating partially or entirely over the inner face; and
optionally applying an enamel, PTFE, ceramic, or sol-gel coating partially or entirely over the outer face.
